(19) United States
(12) Patent Application Publication
(10) Pub. No.: US 2015/0262127 A1
(43) Pub. Date: Sep. 17, 2015

(54) GENERATION AND OPTIMZATION OF IN-MEMORY DATABASE BUSINESS RULE LOGIC

(71) Applicants: Carsten Ziegler, Walldorf (DE); Martin Tomov, London (GB)

(72) Inventors: Carsten Ziegler, Walldorf (DE); Martin Tomov, London (GB)

(21) Appl. No.: 14/215,262

(22) Filed: Mar. 17, 2014

(51) Int. Cl. G06Q 10/10; G06F 17/30

(52) U.S. Cl. CPC G06Q 10/10; G06F 17/30876

(57) ABSTRACT

An example computer implemented method comprises receiving a business rule function in a business rule management application, wherein the business rule function defines one or more rules defined to act on one or more database objects to obtain one or more business rule function results and one or more expressions to be called within a respective rule, wherein an expression is a self-contained operation unit defining a result object, receiving a selection of one or more in-memory database objects of an in-memory database to be processed by the business rule function and providing to an application server of the in-memory database at least a part of the business rule function in the in-memory database for execution on at least a portion the selected one or more in-memory database objects, wherein execution of the at least a part of the business rule function includes receiving only a portion of the selected one or more selected in-memory database objects onto on an application server of the in-memory database, wherein the portion of the one or in memory database objects is determined in response to an evaluation of the business rule function.

### TECHNICAL FIELD

The present disclosure relates to methods and systems for database systems. In particular, the present disclosure relates to a method for processing business rule logic in an in-memory database and optimization of such processing.

### BACKGROUND

Today, many software vendors offer business rule management applications. These business rule management applications can empower users having no or little expertise in programming of database applications to set up, modify and manage business rules. In order to achieve this goal, business rule management applications can facilitate the user to input a business rule (e.g., “if last year's sales for customer A have been higher than 1.000.000 $US, grant a 20% discount”) with a syntax close to the syntax business users are used to in their everyday work. Many business rule management applications have developed domain specific programming languages that can process these inputs into executable code.

On the other hand, businesses assemble vast amounts of data. Ideally, this data can be processed at near real-time in the business intelligence applications. In addition, changes in the data should be propagated as fast possible to avoid running business logic on outdated data. An in-memory database is a database management system that primarily relies on main memory for computer data storage. It is contrasted with database management systems that employ a disk storage mechanism.

### SUMMARY

In a first general aspect of the present disclosure, a computer implemented method comprises receiving a business rule function in a business rule management application, wherein the business rule function defines one or more rules defined to act on one or more database objects to obtain one or more business rule function results and one or more expressions to be called within a respective rule, wherein an expression is a self-contained operation unit defining a result object, receiving a selection of one or more in-memory database objects of an in-memory database to be processed by the business rule function and providing to an application server of the in-memory database at least a part of the business rule function in the in-memory database for execution on at least a portion the selected one or more in-memory database objects, wherein execution of the at least a part of the business rule function includes receiving (e.g. fetching) only a portion of the selected one or more selected in-memory database objects on an application server of the in-memory database, wherein the portion of the one or in memory database objects is determined in response to an evaluation of the business rule function.

In a second aspect according to the first aspect, the method further comprises translating the business rule function into an in-memory database application function in a language executable by an in-memory database application.

In a third aspect according to the second aspect, the language is JavaScript, C++ or L.

In a fourth aspect according to the second or third aspect, translating the business rule function includes identifying a set of input parameters of the business rule function, for each rule of the one or more rules of the business rule function, identifying the one or more expressions called within the respective rule and sequentially translating each rule including its expressions into the language executable by the in-memory database application.

In a fifth aspect according to anyone of the second to fourth aspects the one or more rules are separated into two or more sets of rules and the method further comprises sequentially translating each set of rules into the language executable by the in-memory database application.

In a sixth aspect according to anyone of the second to fifth aspects the method further comprises defining one or more data objects holding the data the one or more rules are defined to act upon.

In a seventh aspect according to the sixth aspect the data objects includes one selected from the list comprising an element, a database table, or a structure combining multiple elements or table, wherein an element is one selected of the group consisting of a number, a string, a number with an associated unit, a point in time or a Boolean value.

In an eighth aspect according to the sixth or seventh aspect the method further comprises including the one or more data objects of the business rule function in a container object.

In a ninth aspect according to anyone of the second to eighth aspects the translated business rule function processes only copies of the input parameters.

In a tenth aspect according to anyone of the second to ninth aspects an expression is selected from the list consisting of a Boolean expression, a case expression, a database lookup expression, a decision table, a decision tree, a search tree, loop, a database table operation, a value range check, and a logic formula.

In an eleventh aspect according to anyone of the second to tenth aspects the in-memory database application is hosted on an application server of the in-memory database is a web server.

In a twelfth aspect according to anyone of the first to eleventh aspects the business rule function defines a condition, and wherein only portions of the in memory database objects meeting the condition are received on (e.g., fetched onto) the application server of the in-memory database.

In a thirteenth aspect according to anyone of the first to twelfth aspects the method further comprises halting the execution of a first expression of the business rule function until a second expression of the business rule function has been executed.

In a fourteenth aspect according to anyone of the first to thirteenth aspects the one or in memory database objects includes one or more database tables, wherein the business rule function defines an operation to be executed on the one or more database tables and wherein the operation defined by the business rule function is executed in the in-memory database.

In a fifteenth aspect according to the fourteenth aspect the operation includes one of the list consisting of an aggregate operation, an average operation, a count operation, a minimum operation, a maximum operation or a select operation.

In a sixteenth aspect according to anyone of the first to fifteenth aspects the portion of the one or in memory database objects is received in two or more separate steps on the application server of the in-memory database.

In a seventeenth aspect according to anyone of the first to sixteenth aspects a first expression of the business rule function is only executed on a selected portion of the one or in memory database objects, wherein the portion is selected based on a second expression.

In an eighteenth aspect according to anyone of the first to seventeenth aspects the expressions of the business rule function include a first expression and a second expression, wherein the first expression and the second expression both are executed in two or more calls on different parts of the one or more database objects and wherein the partial calls of the first and second expressions are executed in an interleaved manner.

In a second general aspect of the present disclosure a computer readable medium storing instructions thereon which when executed by a processor cause the processor to perform operations of any method of the first to eighteenth aspects.

In a third general aspect of the present disclosure a system comprises one or more processors and a computer-readable medium storing instructions executable by the one or more processors to perform operations of any method of the first to eighteenth aspects.

### BRIEF DESCRIPTION OF THE DRAWINGS

FIG. 1 illustrates an example in-memory database system.

FIG. 2 illustrates a business rule management system and in-memory database system.

FIG. 3 illustrates an example process for translating a business rule management function into an in-memory database object.

FIG. 4 illustrates an example computer implemented method for executing business logic in an in-memory database.

### DETAILED DESCRIPTION

This disclosure relates generally to methods and systems for database systems. In particular, the present disclosure relates to a method for processing business rule logic in an in-memory database and optimization of such processing.

The subject-matter described in this disclosure can be implemented in particular embodiments so as to realize one or more of the following advantages.

First, business logic can be defined in business rule management application and then transported and at least partially executed in an in-memory database. In this manner, non-technically skilled users can still define and maintain business rules in an intuitive manner. At the same time the processing speed benefits of in-memory database applications can be exploited.

Second, the distribution of tasks between a business rule management application and an in-memory application can be optimized. This can result in further enhancements of the processing speed of business rule logic.

Third, business logic defined in a business rule management application and translated into code executable by an in-memory database application can be optimized. In this manner, further processing speed advantages can be realized.

Subsequently, in a first part of this detailed description the process of translating a business logic defined in a business rule management application into code executable by an in-memory database application. In a second part of this detailed description, optimization techniques for this code executable by an in-memory database application will be discussed. This separation is for clarity's sake only. The techniques described in both parts do not have to be executed sequentially. For example, already during generation of code executable by an in-memory database application as described in the first part the optimization techniques discussed in the second part can be carried out.

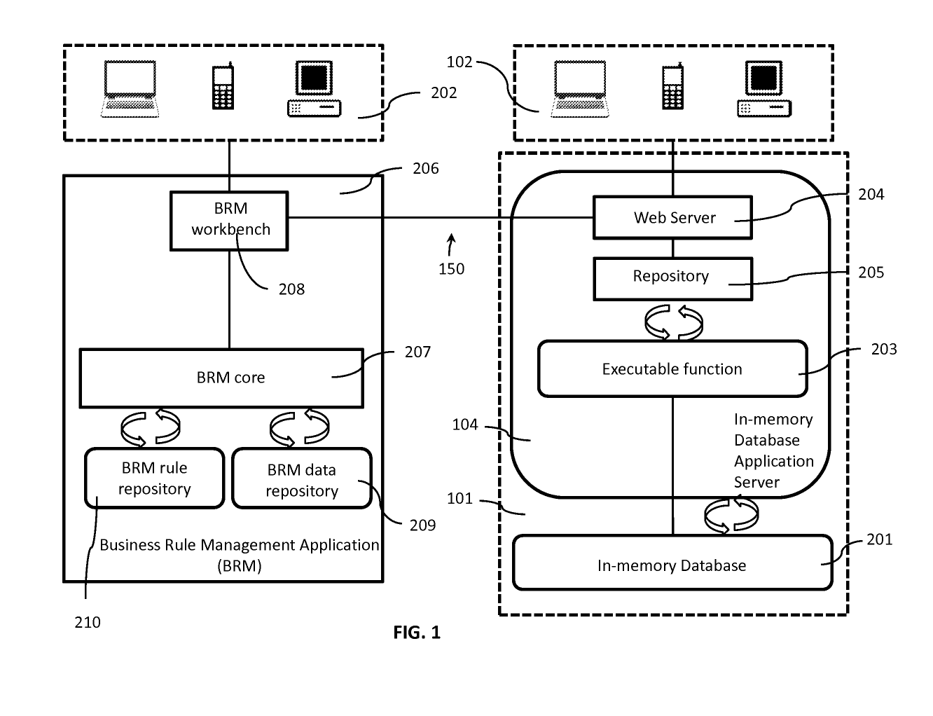

Firstly the structure of an example business rule management application and an example in-memory database application will be described in connection with FIG. 1.

A business rule management application 206 includes a business logic workbench 208, a business rule management application core 207, a business rule repository 209, and a business data repository 210. The business rule management application can be accessed by a user via a user device 202. The user device 202 can include, e.g., any suitable device including a personal computer, a mobile device, or a workstation. The business rule management application 206 can be hosted on the application layer of a business intelligence system.

The different functional units of the business rule management application 206 will subsequently be explained in more detail. The business logic workbench 208 can provide an environment for a user to organize, manage, define and modify business logic. It can include search and navigation functions to find predetermined business logic objects. Moreover, it can include tools to create and change business logic objects. It can be equipped with a graphical user interface for presentation on one or more user devices 202. For instance, a user can access the business rule management application via a mobile device and define a new business rule. The business rule application core 207 can receive the defined business rules from the business logic workbench 208. Thus, the business logic workbench 208 provides a business logic authoring environment. In addition, the business logic workbench 208 can present a user with results of the application of business logic on data in a data base. The business rules received from the business logic workbench 208 can be stored in a business rule repository 210. In addition, the business rule application core 207 can retrieve business rules defined earlier from the business rule repository 210 and transmit them to the business logic workbench 208. Moreover, the business rule application core 207 can include a business rules engine for generating executable code from the business rules defined by the user on the business logic workbench 208, and for executing the generated code on data from a data repository 209. The data repository 209 can be any database including the business data of the user.

In some prior art business rule management applications, the data repository 209 included persistent memory to cope with potentially large amounts of business data. Access times to this persistent memory might be comparatively slow. Therefore, when executing one or more business rules defined in the business rule management application, the required database objects (e.g., a table including the sales data for 2013) were loaded into the memory of the application server hosting the business rule management application. Subsequently, the respective business logic can be applied to the loaded database objects.

In the example system of FIG. 1 an alternative approach to deploy the defined business logic is illustrated. Instead of executing the business logic on the application server of the business rule management application, the defined business rules are translated to be deployed in an in-memory database application and at least partially executed on an in-memory database application server. Before this process is explained in more details, the structure and components of the in memory database will be explained.

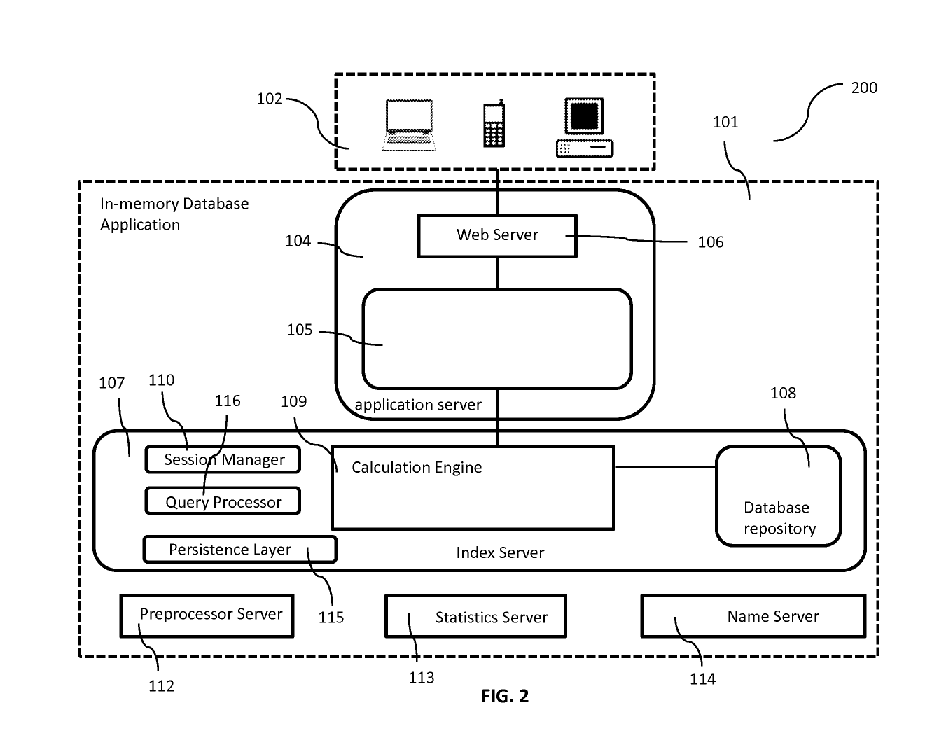

An example in-memory database application 104 is shown on the right hand side of FIG. 1. FIG. 2 shows a more detailed overview over the functional units of an example in memory database application 101. The in-memory database application 101 includes a separate application server 104 configured to run an application 105 for accessing other components of the in-memory database application 101. In one example, the separate application server 104 includes a web-server (reference numeral 106 in FIG. 2). In one example, the separate application server 104 can interpret JavaScript (alternatively or in addition, the application server 104 can interpret C++ or L). A user can access the separate application server 104 via a user device 102 (e.g., a personal computer, a mobile device or a workstation). A graphical user interface of the in-memory database application can be presented on the user device 102 to allow a user to access the in-memory database application. In one example, the communication between the user device 102 and the separate application server 104 uses the HTTP/HTML protocol. Besides the separate application server 104, the in-memory database application 101 can include an index server 107, a preprocessor server 112, a statistics server 113, and a name server 114. The name server 114 is configured to record a topology of the in-memory database. The statistics server 113 is configured to analyze and present status, performance, and metrics from different in-memory database components, as well as the underlying hardware and operation system. The preprocessor server 112 is configured to analyze text data and extract data from text when called via a search function. The index server 107 contains the actual data and engines to process the data. For example, the index server can host an in-memory database repository 108 and a calculation engine 109. The index server 107 can process data queries submitted via the separate application server 104 (or an external application). Moreover, the index server 107 can include a session and transaction manager 110 and a query processor 116 for managing and interpreting incoming database queries. In one example, the calculation engine 109 can process queries in one or more predetermined programming languages. For instance, the predetermined programming languages can be a structured query language or another language for programming database applications. Furthermore, the index server application 107 can include a persistence layer 115 to manage and store particular data of the index server 107 in a persistent memory (e.g., data logs and transaction logs). By providing a calculation engine 109 in the in-memory application, the in-memory database application is capable of running complex procedures in-memory. Even though a particular in-memory database layout has been described above, the techniques described herein are not limited to an in-memory database having this particular layout.

After having explained the layout of example business rules management applications and in-memory database applications, the combination of both applications to allow definition and execution of business logic will be discussed. As can be seen in FIG. 1, the system described herein provides for a connection 150 between the business rule management application 208 and the separate application server 104 of the in-memory database application. However, in other examples, the business rule management application 208 can interface with the in-memory database application 101 via other interfaces than the separate application server 104.

In the example if FIG. 1, the separate application server 104 provides an application programming interface 204 to deploy functions defined on the business logic workbench 208. These functions defined on the business logic workbench 208 can be pushed in an in-memory database application server repository 205. For example, the functions can be contained in the in-memory database application server repository 205 in a language executable by the separate application server 104 of the in-memory database. In FIG. 1, a particular function 203 defined on the business logic workbench 208 and translated into language executable by the separate application server 104 is shown for the sake of illustration. As shown in FIG. 1, the function 203 is executed on the separate application server 104 of the in-memory database application. In this manner, the function can operate on database objects in the in-memory database repository 201 of the in-memory database application. The function 203 can include code in any programming language interpretable by the separate application server 104. In one example, the function 203 is a JavaScript (or C++ or L) function. The separate application server 104 can be hosted in the same physical server as a main index server of the in-memory database application. In this manner, the function 203 executed on the separate application server 104 can access the in-memory database repository 201 with comparatively low latency. On the other hand, the function 203 can be authored by a user in the business rule management application (thus, taking advantage of the intuitive business rule generation environment) and executed (at least partially) on a different application server of the in-memory database (e.g., the separate application server 104). In this manner, the processing of the business logic can be accelerated compared to a solution where the business logic is executed on the business rule management application server 206 (e.g., by the business rule management application core 207).

Moreover, function 203 can also be called via other applications besides the business rule management application 206. In one example, the function 203 can be called via user devices 102. For example, the function 203 can be called via a request over the HHTP protocol.

As shown in FIG. 1, the function 203 is executed on the separate application server 104 of the in-memory database application. In other examples, the function can be executed on other parts of the in-memory database application. For instance, the function can be executed on the index server 107 of the in-memory database application 102 (see FIG. 2). In these examples, the advantages discussed above can also be obtained as the function is executed such that in-memory data can be accessed with low latency.

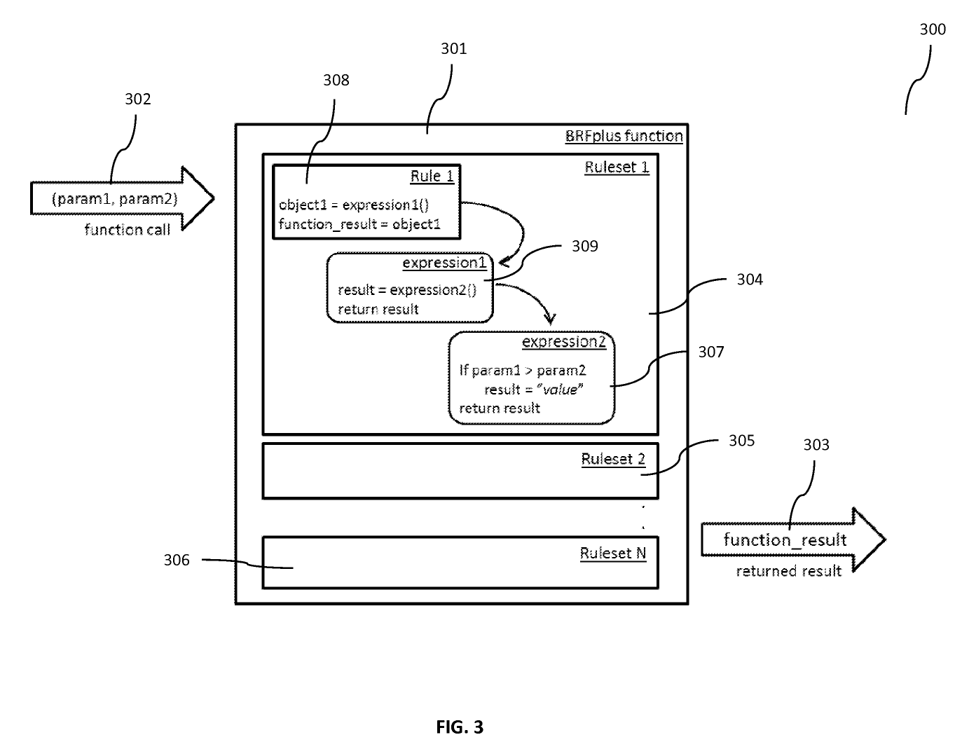

In connection with FIG. 1 and FIG. 2 authoring and execution of a function implementing business logic has been discussed. Subsequently, in connection with FIG. 3, the generation of code executable in the in-memory database application will be explained in more detail. In particular, the process of FIG. 3 can be used to generate code in a programming language executable on components of the in-memory database application from a business rule management function defined in a business rule management application (which, e.g., can employ a domain specific programming language).

Before this code generation process is detailed, example objects of a business rule management application are explained. A business rule management application can be a container to organize and manage business rule objects.

A business rule function can be defined by a user as a container for a predetermined piece of business logic. As depicted in FIG. 3, the business rule function 301 defines a set of one or more input parameters 302 (“param1” and “param2” in FIG. 3). The set of or more input parameters 302 is also denoted as “context” of the business rule function 301. An input parameter can be any type of data object. For example, an input parameter can be an element, a database table, or a structure combining multiple elements or tables, where an element is one selected of the group consisting of a number, a string, a number with an associated unit (e.g., an amount with a corresponding currency indictor or a measurement value with a corresponding measurement unit), a point in time, or a Boolean value, as well as any other suitable value. In addition, the business rule function 301 defines one or more business rule function results 303 (“function result” in FIG. 3). Again, each business rule function result 303 can be any type of data object. For example, a business rule function results 303 can be an element, a database table, or a structure combining multiple elements or table, wherein an element is one selected of the group consisting of a number, a string, a number with an associated unit, a point in time, or a Boolean value, as well as any other suitable value.

A body (i.e., the internal structure) of the business rule management function 301 can contain one or more additional business rule objects. Firstly, a business rule management function 301 can define one or more expressions 307, 309. An expression is a self-contained operation unit defining a result object. For instance, an expression can be selected from, among other suitable expression types, a Boolean expression (e.g., for performing logical operation such as AND, OR), a case expression (e.g., several IF-statements in a chain), a database lookup expression (for fetching data from a database), a decision table (for sequentially processing business rules), a decision tree (e.g., a binary tree like graph modeling decisions), a search tree (where a more than three child nodes can be associated with a parent node), a loop expression (a container for a set of business rules to be executed several times), a database table operation (e.g., an aggregate operation, an average operation, a count operation, a minimum operation, a maximum operation or a select operation), a value range check (to check if a particular value lies within a particular range), and a logic formula. Other types of expressions can also be used.

In the example of FIG. 3, a second expression 307 compares the input parameters “param1” and “param2” and assigns a predetermined value to the data object “result” based on this comparison. A somewhat more complex example of an expression is a search tree expression. For example, the search tree expression can determine if the values in a database column lie between 100 and 200 in a first step and if the currency is US$ in a second step. In response to each determination, the value of a result data object can be set (e.g., a string between “100 and 200 $US”). As can be seen in this example, an expression models a particular business rule operation and returns an output.

A rule object 308 can be a basic object of the business rule management application. It can take the form of an “IF-THEN-ELSE” statement. As shown in FIG. 3, a rule can call one or more expressions 307, 309 containing the business logic and data processing operations of the particular rule. In the example of FIG. 3, a rule 308 (“Rule_{—}1”) has the form “IF param1>param2 set result equal to value.” For instance, “param1” could be an aggregated amount of sales in a predetermined year. “Param2” could be a threshold for a certain discount on future sales and “value” could be the value of the discount (e.g., 20%). One or more rules can be combined in a rule set assigned to the business rule function. In the example of FIG. 3, the business rule function 301 has three assigned rule sets 304, 305, 306. Only one rule is depicted in FIG. 3 for the sake of illustration. The rule sets can have relative or absolute priorities to define an execution order in the business rule function 301. A rule set with a relatively higher priority can be processed completely before processing of a rule set with a lower priority is started. In addition or alternatively, a rule set can have one or more pre-conditions. In this case, the pre-conditions are checked before a processing of the rules in a rule sets commences. If the pre-conditions are not satisfied, processing of the rule set can be skipped or processing of the rule set can be halted.

Moreover, a business rule function 301 can define one or more actions (not shown in FIG. 3). An action can be a predefined task to be performed by the business rule management application once a predetermined rule is evaluated to be true or false. Example actions are sending an email or triggering a call of another business rule function.

After having explained the basic business rule objects, the generation of code executable in an in-memory database application will be discussed. In one example, a JavaScript (or C++ or L) function can be generated that can be executed on a separate application server (e.g., separate application server 104 in FIG. 1 and FIG. 2) of an in-memory database application. The process for generating the code executable in the in-memory database application follows the design time specification of the business rule management application. The generation of the code can be performed in a decision service application. In one example, the decision service application is hosted on the business rule management application server (not shown in FIG. 1). In one example, the decision service provides a predetermined set of standard methods (e.g., for defining data objects and changing the values of data objects).

In a first operation, a user can create, in the business rule management application, a business rule function 301 to define a predetermined piece of business logic. For instance, a team manager can create a business rule function 301 to calculate last year's bonuses for the members of her team. The user can select the input parameters (e.g., tables including performance data of the team members, the company's bonus rules) of the business rule function 301 and one or more output parameters (e.g., the bonus for each team member). In the business rule management application, the business logic workbench 208 can provide a graphical user interface to create or modify a business rule function 301. The code generation process follows this design time action of the user and generates a function in the language executable by the in-memory database application (e.g., JavaScript, C++ or L). The input parameters of the business rule function 301 become arguments of the generated function executable by the in-memory database application (also referred to as “in-memory database application function” herein). The in-memory database application function can include an identifier, a name and additional metadata (e.g., the generation time of the function).

In the process of defining the business rule function 301, the user can create, select, and/or modify one or more of the business rule objects discussed above (i.e., rules, expressions, rule sets, data objects, and actions). As explained above, these business rule objects can be interpreted as part of the body of a business rule function 301 (see FIG. 3) and translated into code executable by the in-memory database application (e.g., by the decision servicer application). For each of the discussed business rule objects, details of this code generation process are discussed below.

For instance, the user can define in the business rule management application a business rule (e.g., “Rule_{—}1” depicted in FIG. 3). The business rule can have the form of an “IF-THEN-ELSE” statement. The rule can include one or more conditions. In the business rule management application, the business logic workbench 208 can provide a graphical user interface to define or modify a business rule. The user can define or select one or more expressions (i.e., self-contained operation units defining a result object) to be evaluated within the business rule. In other words, the one or more expressions are called within the rules. In the business rule management application, the user can either define or select the expressions within the graphical user interface for defining or modifying a business rule, or in a separate graphical user interface provided by the business logic workbench 208. The code generation process (e.g., run in the decision service application) to generate a function interpretable by the in-memory database application identifies each rule and each expression defined by the user in the business rule management application. For each rule defined by a user in the business rule management application an “IF-THEN-ELSE” construct in the body of the in-memory database application function is created. For each expression to be evaluated within the business rule, a function encapsulating the self-contained operation unit of the expression is defined and respective code executable on the in-memory database application is generated. The functions encapsulating the self-contained operation unit of an expression includes a returnable data object which corresponds to the output object of the respective expression. Function calls of the defined functions encapsulating the self-contained operation unit of the expression are inserted into the “IF-THEN-ELSE” construct in the body of the in-memory database application function is created. In some examples, functions encapsulating the self-contained operation unit of the expression can be called within another function encapsulating the self-contained operation unit of another expression (see, e.g., the example of FIG. 3 where “expression2” is called within “expression1”).

The user of the business rule management application can define a rule set including one or more rules. For each rule set, a container object is generated in the in-memory database application function. The business rules of the rule set are called sequentially within the rule set. In one example, an order of the calls can be identical to the order of the business rules in the business rule management application.

If the user defines a data object in the business rule management application (a list of possible data objects can be found above), a variable of the in-memory database application function is defined. In some example, all variables of the in-memory database application function are inserted into a container object. The variables can be accessed in this container object by using an identifier of the respective variable.

In some examples, functions encapsulating the self-contained operation unit of the expressions only work with copies of the variables of the in-memory database application function. This can support that a first function encapsulating the self-contained operation unit of one expression can call a second function encapsulating the self-contained operation unit of another expression (and so on).

The order of the example business rule function generation process of the previous paragraphs is not essential for the business rule function generation process or the code generation process. A user of the business rule management application can define business rule objects in different orders. The code generation process can happen sequentially, or in one shot after the user of the business rule management application has finished the definition of a business rule function.

The decision service application, or any other component hosting the code generation process, can keep a registry of already generated functions encapsulating the self-contained operation unit of an expression or of “IF-THEN-ELSE” constructs representing a rule. This registry can be used to only generate code for new expressions and rules. If a rule or expression already present in the registry is re-used by a user of the business rule management application, the code included in the registry can be used.

It has been described in the previous passage how code executable in an in-memory database application (e.g., on the application server of an in-memory database application) can be generated from a business rule function defined in a business rule management application (e.g., a JavaScript function). This code can be deployed on an application server of the in-memory application and can be called from the business rule management application as well as from other external applications. This can result in a faster delivery of the results of the application of defined business logic on business data. In the subsequent paragraphs, several optimization techniques will be described which might result in an even further acceleration of the execution of business logic on business data. These optimization techniques can be used during the code generation process described in the previous paragraphs, or in a separate optimization operation.

In one example, the optimization includes fetching only a portion of one or more selected in-memory database objects onto an application server of the in-memory database application (e.g., separate application server 104 in FIG. 1 and FIG. 2), where the portion of the one or in memory database objects is determined in response to an evaluation of the business rule function. In this manner, intense computations can be executed in the in-memory database which might be faster compared to an execution on, e.g., an application server of the business rule management application. In addition, fetching only portions of the selected in-memory database objects might result in an accelerated processing of the defined business logic. In some prior art systems where the business logic is executed on an application server of a business rule management application, the entire selected database objects are fetched and processed subsequently to reduce the number of separate database queries to a minimum.

In another example, the in-memory database application function can define a condition and only portions of the in memory database objects meeting the condition can be fetched onto the application server of the in-memory database application (e.g., a row or a column of a database table meeting a predetermined condition). Alternatively or in addition, the in-memory database application function can be optimized such that the execution of a first expression of the business rule function is halted until a second expression of the business rule function has been at least partially executed. For instance, the execution of a database lookup expression can be halted until a table operation has been executed. Alternatively or in addition, a first expression of the in-memory database application function acting on a particular data object can be executed in a modified manner if a second expression acting on the particular database object is called within the in-memory database application function. For example, the first expression can be called in two or more separate calls. Alternatively or in addition, the portion of the database object the first expression acts upon can be modified (e.g., the first expression can be modified to act upon only a subset of data of the portion of the database object).

Alternatively or in addition, a first expression of the in-memory database application function can only be executed on a selected portion of the one or in memory database objects, where the portion is selected based on an existence and/or an evaluation of the second expression. Alternatively or in addition, a first expression and a second expression of the in-memory database application function can both be executed in two or more separate calls on different parts of one or more selected database objects, where the partial calls of the first and second expressions are executed in an interleaved manner. For example, a database lookup expression for fetching data from the in-memory database can be split into multiple calls. In each call, only a portion of a selected in-memory database object can be fetched (e.g., only one column of a database table). Between two consecutive calls of the database lookup expression a second expression (e.g., a database table expression) can be called and executed on the particular portion of the database object.

In one example of the above described optimization techniques, a first expression is a database lookup expression and the second expression is an operation on a data object of the type table (for instance, one operation of the list consisting of an aggregate operation, an average operation, a count operation, a minimum operation, a maximum operation or a select operation). A database lookup expression retrieves data from a table in a database and stores this data in a data object of the type table on the application server. There, the data object can be used to perform further operations. In some prior art applications, all data to undergo one or more table operations is, in a first operation, loaded onto the application server. This might lower the number of database access operations which can accelerate the execution of the business logic (as latency in accessing the database can be an important factor). As explained above, business logic can be executed in an in-memory database application which can reduce the access latencies.

In one example, a database lookup expression and an expression including a table operation are identified in an in-memory database application function. Instead of executing these expressions sequentially, both expressions are merged into a single select expression bringing only the result of the table operation executed on the one or more in-memory database objects to the application server of the in-memory database. This behavior can be implemented in the following manner. When the database lookup expression is called in the in-memory database application function, a respective database object (e.g., a database table) is marked and the execution of the database lookup expression is held until a later point in the program flow. For example, the variable including the database object might include a flag field and the flag can be set as soon as the database lookup expression is called. After marking the database object, the expression including a table operation is executed on the database object and the result of the table operation is returned to the application server. This behavior can be implemented by including a condition in the code before calling the expression including a table operation. It can be checked if a flag is set or not. If no flag is set, a normal execution of the expression including a table operation can be executed. If a flag is set, the expression including a table operation is executed and the results are returned to the application server (in one or more portions). For example, the expression including a table operation can be an aggregate operation to calculate the aggregate of a column of a database table and return the result of this aggregation operation. Instead of fetching the complete database table, the database lookup expression is halted and an aggregate operation is performed on a first database table column. The result of this aggregate operation can be returned. Then, an aggregate operation is performed on a second database table column and the result of this second aggregate operation is returned and so on.

In another example, a database lookup expression and a loop expression are identified in an in-memory database application function. A loop expression repeats one or more operations a pre-defined number of times over a database object (e.g., the rows of a table). In addition, a set of one or more select conditions can be specified and the loop expression should only be executed on portions of the database object fulfilling the one or more conditions. Instead of retrieving the complete database object (e.g., all tables of a database table), the database lookup operation can be halted and the select operations can be evaluated first. This select operation can return only the portions of the database object (e.g., columns of a database table) fulfilling the one or more conditions. The operations defined within the loop expression can only be executed on these selected portions of the database object. This behavior can be implemented in a similar manner as described above for a database lookup expression and an expression including a table operation. A database object subject to a database lookup expression can be flagged and the execution of the database lookup expression can be halted. In a next operation, the existence of a previous database lookup expression is checked before the condition expression is executed. If the database object (e.g., a database table) is flagged, only portions meeting the conditions are returned by the database lookup expression. The loop expression can then be executed on these selected portions of the database object.

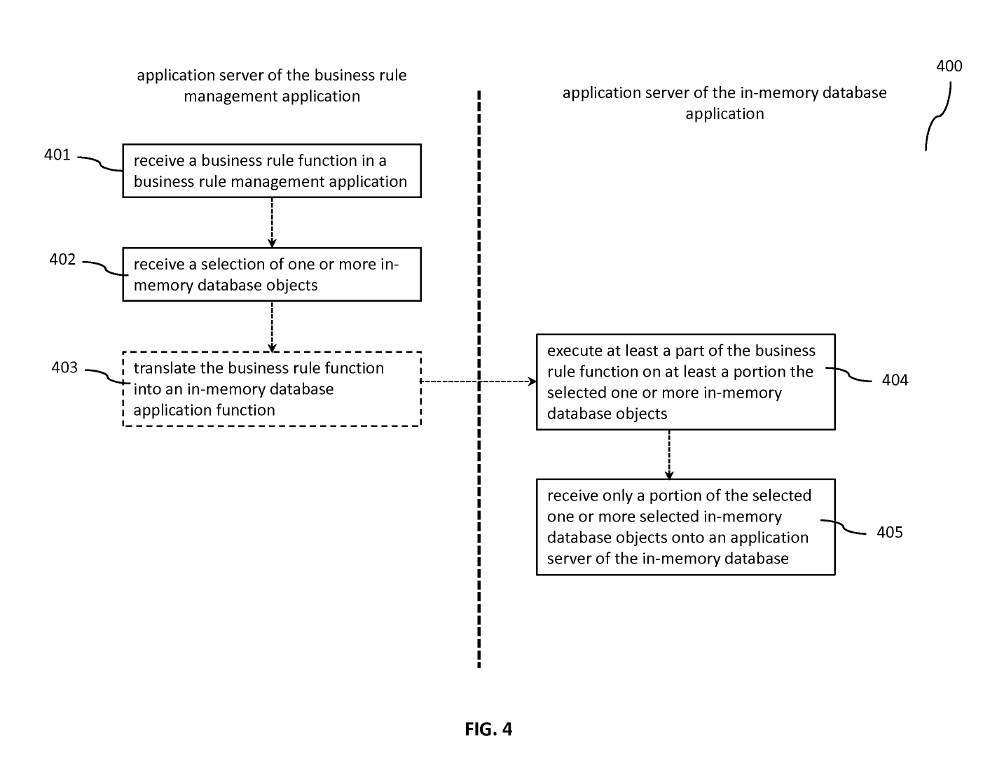

In the receding sections, several aspects of business rule generation and execution techniques where some operations are performed on an application server of the business rule management application and other operations are executed on an application server of the in-memory database application have been discussed. FIG. 4 illustrates an example method implementing business rule generation and execution techniques. In one operation, a business rule function is received (401) in a business rule management application, wherein the business rule function can include the above described elements. For instance, the business rule function can define one or more rules or one or more rules organized in one or more rule sets, where the one or more rules are defined to act on one or more database objects to obtain one or more business rule function results and one or more expressions to be called within a respective rule (an expression being a self-contained operation unit defining a result object). In a second operation, a selection of one or more in-memory database objects of an in-memory database to be processed by the business rule function is received (402). Then, the business rule function is deployed on an in-memory database. This can include translating (403) the business rule function into an in-memory database application function in a language executable by an in-memory database application. Any of the methods for generating code executable in the in-memory database discussed above can be employed. In a next optional operation, at least a part of the business rule function is executed (404) in the in-memory database on at least a portion the selected one or more in-memory database objects. In other examples, the process stops once the executable code is generated. In a further optional operation, only a portion of the selected one or more selected in-memory database objects is fetched (405) onto an application server of the in-memory database.

At a high level, the servers and other components of a business rule management application and an in-memory database application described above as functional units are associated with a computer or processor. A computer or processor comprises an electronic computing unit (e.g., a processor) operable to receive, transmit, process, store, or manage data and information associated with an operating environment of the database system. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations, e.g. in a manner that the operations are distributed among the two or more processors. The processor may comprise multiple organic field-effect transistors or thin film transistors or a combination thereof. This may allow processing the operations in parallel by the two or more processors. The two or more processors may be arranged within a supercomputer, the supercomputer may comprise multiple cores allowing for parallel processing of the operations. For instance, computer or processor may be a desktop or a laptop computer, a cellular phone, a smartphone, a personal digital assistant, a tablet computer, an e-book reader or a mobile player of media. Furthermore, the operating environment of the database system can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device”, “server” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures. In enterprise systems, there are OLTP (OnLine Transaction processing) systems used to carry out business processes of a company where employees and other stakeholders, such as suppliers or customers, follow a business process which may result in business documents created in a database of the OLTP system. The database system can include in-memory databases in addition to the persistent databases described in connection with FIGS. 1 and 2 and thereby exploit recent innovations in hardware to run a database in main memory. In an implementation of the present disclosure described herein, the servers may be types of a Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC), a ByDesign platform, SuccessFactors Platform, ERP Suite technology or in-memory database such as High Performance Analytic Appliance (HANA) platform. In an aspect, the servers may be based on two different of the above mentioned platforms.

Regardless of the particular implementation, “software” or “operations” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, the database system operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the operations in these processes may take place simultaneously, concurrently, and/or in different orders or combinations than shown. Moreover, operating environment may use processes with additional operations, fewer operations, and/or different operations, so long as the methods remain appropriate.

Aspects of the subject-matter and the operations described in this specification can be implemented in digital electronic circuitry, semiconductor circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) or “user interface” can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) “icons”, some or all associated with a web browser, such as interactive fields, pull-down lists, and buttons operable by the user of the computing device hosting the UI. These and other UI icons may be related to or represent the functions of the web browser. The term “browser user interface” refers to a graphical user interface embedded in a web browser environment on the remote computing device. The browser user interface may be configured to initiate a request for a uniform resource locator (URL) and may be configured to display a retrieved web page such as an HTML coded web page. The browser user interface may comprise displayed or hidden icons which, upon activation, initiate an associated electronic process inside or outside the remote computing device. For example, the browser user interface may be Internet Explorer, Chrome or Firefox. “Creating an icon” is to be understood as generating a new icon on the user interface. “Modifying an icon” is to be understood as changing a property of an existing icon on the user interface. “Deleting an icon” is to be understood as vanishing an existing icon on the user interface, e.g., for replacement by a newly created icon. “Updating the user interface” thereby is to be understood as creating, modifying, or deleting an icon on the user interface.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the user interface described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Implementations of the subject-matter described in this specification can be implemented in a computing system that includes a back end component, e.g., as a server, or that includes a middleware component, e.g., an application server, or that includes a front end component, e.g., a user computer having a graphical user interface or a Web browser through which a user can interact with an implementation of the subject-matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any implementation or on the scope of what may be claimed, but rather as descriptions of features that may be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer implemented method, comprising:
receiving a business rule function in a business rule management application, wherein the business rule function defines:
one or more rules defined to act on one or more database objects to obtain one or more business rule function results, and
one or more expressions to be called within a respective rule, wherein an expression is a self-contained operation unit defining a result object;
receiving a selection of one or more in-memory database objects of an in-memory database to be processed by the business rule function; and
providing to an application server of the in-memory database at least a part of the business rule function in the in-memory database for execution on at least a portion the selected one or more in-memory database objects, wherein execution of the at least a part of the business rule function includes receiving only a portion of the selected one or more selected in-memory database objects on an application server of the in-memory database, wherein the portion of the one or in memory database objects is determined in response to an evaluation of the business rule function.

2. The computer implemented method of claim 1, further comprising:
translating the business rule function into an in-memory database application function in a language executable by an in-memory database application.

3. The computer implemented method of claim 2, wherein the language is JavaScript, C++ or L.

4. The computer-implemented method of claim 2, wherein the translating the business rule function includes:
identifying a set of input parameters of the business rule function;
for each rule of the one or more rules of the business rule function,
identifying the one or more expressions called within the respective rule; and
sequentially translating each rule including its expressions into the language executable by the in-memory database application.

5. The computer-implemented method of claim 4, wherein the one or more rules are separated into two or more sets of rules, the method further comprising:
sequentially translating each set of rules into the language executable by the in-memory database application.

6. The computer implemented method of claim 4, further comprising:
defining one or more data objects holding the data the one or more rules are defined to act upon.

7. The computer implemented method of claim 6, wherein the data objects includes one selected from the list comprising an element, a database table, or a structure combining multiple elements or table, wherein an element is one selected of the group consisting of a number, a string, a number with an associated unit, a point in time or a Boolean value.

8. The computer implemented method of claim 6, further comprising including the one or more data objects of the business rule function in a container object.

9. The computer implemented method of claim 4, wherein the translated business rule function processes only copies of the input parameters.

10. The computer implemented method of claim 4, wherein an expression is selected from the list consisting of a Boolean expression, a case expression, a database lookup expression, a decision table, a decision tree, a search tree, loop, a database table operation, a value range check, and a logic formula.

11. The computer implemented method of claim 2, wherein the in-memory database application is hosted on an application server of the in-memory database is a web server.

12. The computer implemented method of claim 1, wherein the business rule function defines a condition, and wherein only portions of the in memory database objects meeting the condition are received on the application server of the in-memory database.

13. The computer-implemented method of claim 1, further comprising:
halting the execution of a first expression of the business rule function until a second expression of the business rule function has been executed.

14. The computer implemented method of claim 1, wherein the one or in memory database objects includes one or more database tables, wherein the business rule function defines an operation to be executed on the one or more database tables and wherein the operation defined by the business rule function is executed in the in-memory database.

15. The computer-implemented method of claim 14, wherein the operation includes one of the list consisting of an aggregate operation, an average operation, a count operation, a minimum operation, a maximum operation or a select operation.

16. The computer-implemented method of claim 1, wherein the portion of the one or in memory database objects is received in two or more separate steps onto the application server of the in-memory database.

17. The computer-implemented method of claim 1, wherein a first expression of the business rule function is only executed on a selected portion of the one or in memory database objects, wherein the portion is selected based on a second expression.

18. The computer implemented method of claim 1, wherein the expressions of the business rule function include a first expression and a second expression, wherein the first expression and the second expression both are executed in two or more calls on different parts of the one or more database objects and wherein the partial calls of the first and second expressions are executed in an interleaved manner.

19. A computer readable medium storing instructions thereon which when executed by a processor cause the processor to:
receive a business rule function in a business rule management application, wherein the business rule function defines:
one or more rules defined to act on one or more database objects to obtain one or more business rule function results, and
one or more expressions to be called within a respective rule, wherein an expression is a self-contained operation unit defining a result object;
receive a selection of one or more in-memory database objects of an in-memory database to be processed by the business rule function;
provide to an application server of the in-memory database at least a part of the business rule function in the in-memory database for execution on at least a portion the selected one or more in-memory database objects, wherein execution of the at least a part of the business rule function includes receiving only a portion of the selected one or more selected in-memory database objects on an application server of the in-memory database, wherein the portion of the one or in memory database objects is determined in response to an evaluation of the business rule function.

20. A system comprising:
one or more processors; and
a computer-readable medium storing instructions executable by the one or more processors to perform operations comprising:
receiving a business rule function in a business rule management application, wherein the business rule function defines:
one or more rules defined to act on one or more database objects to obtain one or more business rule function results, and
one or more expressions to be called within a respective rule, wherein an expression is a self-contained operation unit defining a result object;
receiving a selection of one or more in-memory database objects of an in-memory database to be processed by the business rule function;
providing to an application server of the in-memory database at least a part of the business rule function in the in-memory database for execution on at least a portion the selected one or more in-memory database objects, wherein execution of the at least a part of the business rule function includes receiving only a portion of the selected one or more selected in-memory database objects on an application server of the in-memory database, wherein the portion of the one or in memory database objects is determined in response to an evaluation of the business rule function.
